(19) United States
(12) Patent Application Publication
(10) Pub. No.: US 2012/0092348 A1
(43) Pub. Date: Apr. 19, 2012

(54) SEMI-AUTOMATIC NAVIGATION WITH AN IMMERSIVE IMAGE

(75) Inventor: David McCutchen, Portland, OR (US)

(73) Assignee: IMMERSIVE MEDIA COMPANY, Portland, OR (US)

(21) Appl. No.: 12/904,887

(22) Filed: Oct. 14, 2010

(51) Int. Cl. G06T 13/00

(52) U.S. Cl. 345/474

(57) ABSTRACT

A View Track accompanying an immersive movie provides an automatic method of directing the user's region of interest (ROI) during the playback process of an immersive movie. The user is free to assert manual control to look around, but when the user releases this manual control, the direction of the ROI returns gradually to the automatic directions in the View Track. The View Track can also change the apparent direction of the audio from a mix of directional audio sources in the immersive movie, and the display of any metadata associated with a particular direction. A multiplicity of View Tracks can be created to allow a choice of different playback results. The View Track can consist of a separate Stabilization Track to stabilize the spherical image, for improving the performance of a basic Navigation Track for looking around. The recording of the View Track is part of the post production process for making and distributing an immersive movie for improving the user experience.

### GENERAL FIELD

This disclosure generally relates to a delivery system for motion picture images according to responses from a user, and to a panoramic image reproduction system.

### BACKGROUND

Typically a still or motion picture appears within a fixed frame, with no options for changing the direction of view. Immersive still and motion pictures (or movies) are a new form of media delivery, involving a digital image that has an extremely wide field of view. The immersive image can take the form of a panoramic strip that can extend 360 degrees around the observer, or a more spherical image that also involves the top or bottom of the spherical field of view. Because both types of immersive image can appear to be too wide image to see at once, a movable region of interest (ROI) window within this overall immersive image is a typical way for the observer to display a portion, or “area of interest” within the immersive image, while also allowing the freedom to move the window to look in other directions at other portions of the immersive image.

The movement of this ROI window is a function of a navigation interface included in a playback application for the immersive image. For the IMViewer application from the Immersive Media Company (IMC), for example, the movement of the ROI window is done by means of a click and drag mouse interface, where clicking on the image allows the observer to drag it to change the viewing direction, with variable speed in the changing of the viewing direction as controlled by the observer. The arrow keys can also be used to change the viewing direction in a more constant direction and speed. However, this freedom of action can leave too many choices available to the observer. During an immersive motion picture recording of a fast-changing or complex scene, the observer may be looking in a direction (i.e., have the ROI window directed in a direction) that causes the observer to miss an important or significant segment of the recording. Accordingly, a guide is needed to help steer the observer toward significant segments or views in an immersive image recording. The IMViewer application from the Immersive Media Company (IMC) includes an option to record a “Viewing Path” in an immersive movie.

The Viewing Path is a record of the location of the ROI window chosen by the observer for every frame of the immersive motion picture. The Viewing Path is saved when a “Record Path” option is activated, and the results are saved with a “Save Path” option. The result is in the form of an associated text file with the azimuth, elevation and zoom settings of the ROI window for each frame in the motion picture. The observer may select a “Use Path” option in which movement of the ROI window during the playback of the immersive movie is controlled automatically to follow the recorded Viewing Path, including during fast forward or rewind playback. The observer can take over manual control of the ROI window by, for example, clicking and dragging to look around in directions other than the Viewing Path, and can resume the automatic control of the ROI window according to the Viewing Path upon a keystroke or menu command.

The operation of the Viewing Path is an illustration of using an accompaniment to an immersive movie as a way to guide an observer's navigation of the ROI window for the best enjoyment of the immersive image. However, this operation of the Viewing Path does not address other limitations in a observer's experience of an immersive movie.

A previous system is directed to guiding the view direction in an immersive still image and does not address the possibilities of a more sophisticated navigation system for immersive motion pictures. In this case, U.S. Pat. No. 6,256,061 by H. Lee Martin, et. al. for “Method and apparatus for providing perceived video viewing experiences using still images” is directed toward steering a observer's view within a still immersive image, to effectively make a “movie” out of a still.

Recently immersive streaming video has been introduced by the Immersive Media Company. An immersive video stream is delivered, usually in the Adobe Flash or Microsoft Silverlight format, and each observer is free to look around within the immersive video stream by making use of a simple software control that is automatically installed on the observer's client side computer as part of the browser interface. The streaming can be done of a live image that is generated on-the-fly, or of previously recorded files that had been stored for playback. Streaming the full immersive image to all observers who request it provides each observer with the maximum ROI navigation flexibility.

However, most observers of immersive movies tend to be passive, in the manner of viewers of regular video, and do not fully explore the range of views available in every direction in immersive movies. If provided with an automatic viewing solution, in the manner of the prior IMC Viewing Path, such observers would still tend to have a passive experience, relying on someone else to do the “looking around” and watching the ROI within an immersive motion picture as if it were simply a regular video. But if they take over the manual control of the ROI direction and do the looking around for themselves, they may get a sense of how much more there is to see in the overall image, but they are not presented with any guidance about how to make the best choice of viewing direction.

For immersive movies in which the camera is rapidly changing its orientation, such as when shooting extreme sports, it is especially difficult to find a consistent viewing solution, either because the camera is in an unusual orientation, or because the camera is changing its orientation at the same time as the user is changing the view direction. If the overall spherical image is tilted or changing significantly, the user will become disoriented very quickly.

The present disclosure addresses the need for a more comprehensive approach to the navigation process within an immersive image.

### SUMMARY

An immersive movie viewing system includes a View Track as part of the playback process. This View Track contains an automatic orientation of an extracted ROI window for each frame of an immersive movie. Manual control by the observer can direct the orientation of the ROI window in another direction, but when the observer's manual control is released or surrendered, the orientation of the ROI window migrates back to the automatic orientation of the View Track, using interpolation to make a smooth transition. Also, multiple View Tracks can be included with each movie and selectively chosen by the observer to enable different viewing experiences, such as tracking a particular character through an immersive scene. The View Track can be made to be multilevel in its effect, with a top level Navigation Track that represents smoothed azimuth and elevation adjustments for looking around, and a Stabilization Track that contains irregular frame-by-frame adjustments to correct for shake or tilting of the immersive camera image, and establish a more level scene for viewing.

### OBJECTS AND ADVANTAGES

It is an object of the present disclosure to provide a method, and an apparatus for applying that method, for recording and editing one or more View Tracks as part of the production process of making an immersive movie.

It is an object of the present disclosure to provide a method, and an apparatus for applying that method, for delivery of one or more View Tracks as an integral part of the playback and viewing process for an immersive movie. Each of these View Tracks contains navigation instructions for the display of a region of interest window within the immersive movie.

It is an object of the present disclosure to provide a method, and an apparatus for applying that method, for allowing switching of the observer's viewpoint among multiple View Tracks accompanying an immersive movie.

It is also an object of the present disclosure to provide a method, and an apparatus for applying that method, for applying the automatic guidance contained in a View Track in a dynamic manner, wherein the user's own manual navigation is mixed in with the stored instrctions from a View Track, and a mix of automatic and manual navigation is allowed that varies over time according to the amount of manual control used.

It is also an object of the present disclosure to provide a method, and an apparatus for applying that method, for separating the View Track into a Stabilization Track containing adjustments related to the orientation of the immersive image itself, and the Navigation Track dealing with looking around within what is assumed to be a stable image.

### BRIEF DESCRIPTION OF THE DRAWINGS

FIG. 1 shows a schematic view of a spherical field of view, and the locations of several successive region of interest windows representing the changes in location represented by different frames of an immersive movie.

FIG. 2 shows a listing of the basic orientation information for a View Track.

FIG. 3 shows a schematic view of successive location centers, as produced by an automatic control from a View Track, manual control departing from the View Track, a gradual return from the View Track after the manual control is released, and a switch to a second View Track.

FIG. 4 shows a separation of a View Track into a Stabilization Track that corrects the orientation of the spherical image, and a Navigation Track which looks around within the stabilized spherical image.

FIG. 5 is a schematic view of the process of the recording of a View Track as part of the post production process.

FIG. 6 is a block diagram of the steps in the capture process for one or more View Tracks.

FIG. 7 is a block diagram showing the selection of one or more View Tracks and the optional assertion of manual control.

FIG. 8 is a schematic overview of the selection of a branching route to a destination.

FIG. 9 is a block diagram of the linkage of immersive movies with branching links.

### DETAILED DESCRIPTION

In the discussion that follows, “immersive” can be understood as representing any wide angle recording, especially one in which more information is recorded than can conveniently be seen at once, necessitating the extraction of a region of interest for viewing. Terms such as “panoramic”, “camera”, “streaming”, “web” and “Internet” are used to describe the function and operation of the present disclosure and an exemplary type of distribution that could make use of the disclosure. No particular limitation should be inferred from these terms; they are used as general descriptors for image generation and delivery. Several commercial immersive image capture systems are available for the production of immersive movies, besides the Dodeca® 2360 Telemmersion® camera system and the Postproduction Suite software of Immersive Media Company. There are also many commercial packages for making immersive stills out of multiple camera images, such as the QuickTime VR Authoring Studio offered by Apple Computer, Inc. In the discussion that follows, terms such as “immersive camera system” and “immersive image’ are used to refer to such systems. No particular limitation should be inferred from these terms; they are used as general descriptors. The use of the term “View” means the addressing of media information in a particular direction, and is not limited only to the presentation of visual information; it can include any soundtracks, metadata such as URL links and media objects or layers which are particular to that direction.

The present disclosure is directed toward more effective playback of immersive movies at an observer's computing device, which may be a computer or any other computer-controlled display and is referred to generically as a computer. The immersive movie may be delivered to and played on the observer's computer as a stream from one or more server computers, with the observer's computer operating as a client of the one or more servers, and all or part of the immersive movie may be delivered to and stored on the observer's computer prior to playback. As is common in the art, the observer's computer includes a display and one or more user interface controls operable by the observer including, but not limited to, a keyboard, mouse interface, joystick, head tracker, eye tracker, etc.

Immersive movies have particular demands on the observer that can require extra help at the time of playback. Without a View Track which that can contain a suggested direction for looking around, the observer can get lost within the wide range of available viewing directions of view, and miss the essential components of the action in the immersive movie. In addition, actions which lead to movement of the immersive camera, such as tilting and shaking of the camera, can produce apparent motions of the immersive image which oppose the changes of view direction which the observer may be trying to make, giving the observer the sense impression that the immersive movie is “fighting” the observer's viewing changes. To help with this, a View Track can automatically guide the viewing direction during playback, except for the times when the observer may wish to have manual control. Multiple View Tracks allow the observer to switch among different scenarios or view sequences for looking at the immersive movie. And a separate Stabilization Track allows for better orientation of the underlying immersive movie for viewing.

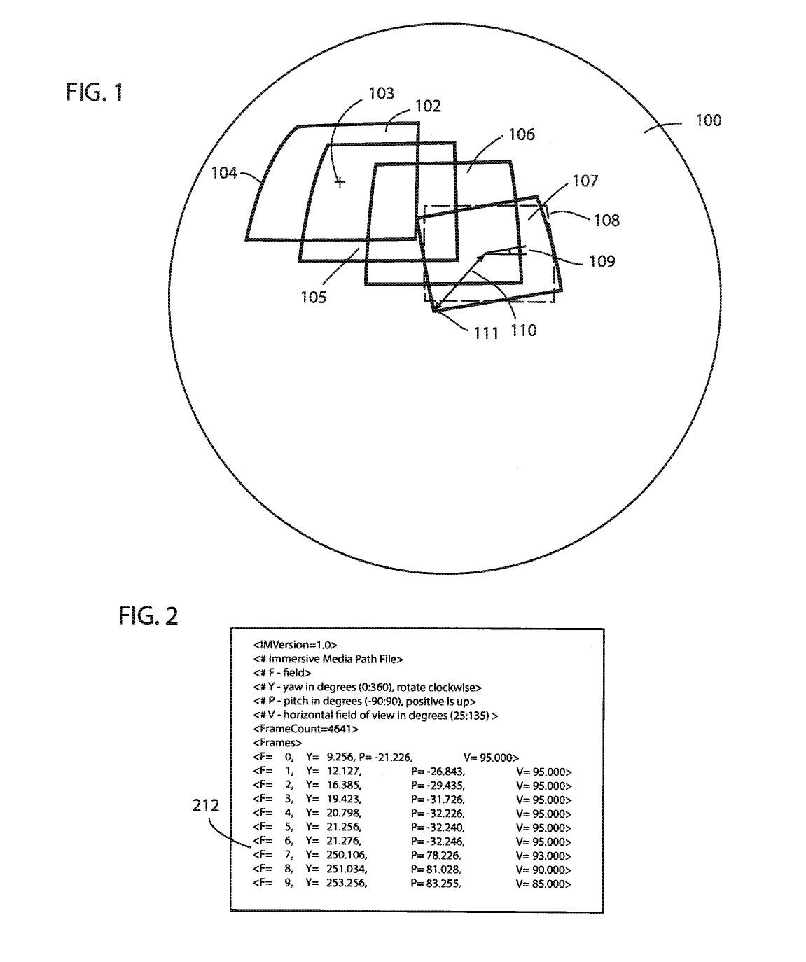

FIG. 1 shows a schematic view of a spherical field of view 100 in an immersive motion picture or movie with multiple ROI windows positioned to illustrate movement of the region of interest over multiple frames of the immersive movie. A first ROI window 102 has a center 103 and an edge 104 representing a given field of view within overall field of pixels in the spherical field of view 100. This spherical field of view 100 can take the form of a faceted or smooth surface, rendered by any of a number of CPU and GPU components. As the frames of the immersive movie increment, this sphere of pixels changes. For simplicity, all of the separate frames are shown here superimposed on one sphere. A second location for a second ROI window 105 for another frame is shown, as well as a third ROI window 106 and a fourth ROI window 107, which has a different field of view 108 having a different window size or shape. The locations of the ROI windows within spherical field of view 100 can be represented by the locations of their centers, either expressed as azimuth and elevation angles, or in terms of absolute pixel locations, combined with a rotation setting 109, representing the rotation of the ROI window around its center, and a field of view setting 110, representing the size or shape of the window. The last two settings can be encoded directly as numbers or indirectly as the location of one corner 111, which implies both the orientation and the field of view.

FIG. 2 shows a listing of the orientation information for each frame of the movie in a simplified form. Note that sudden changes of direction can be done during playback, such is shown for the transition 212 from frame 6 to frame 7; this has the effect of a cut from one area of spherical field of view 100 to another. This listing can be in the form of a binary text file, xml file, or other metadata file format, and can be a separate file accompanying the movie itself, or be embedded in the movie header.

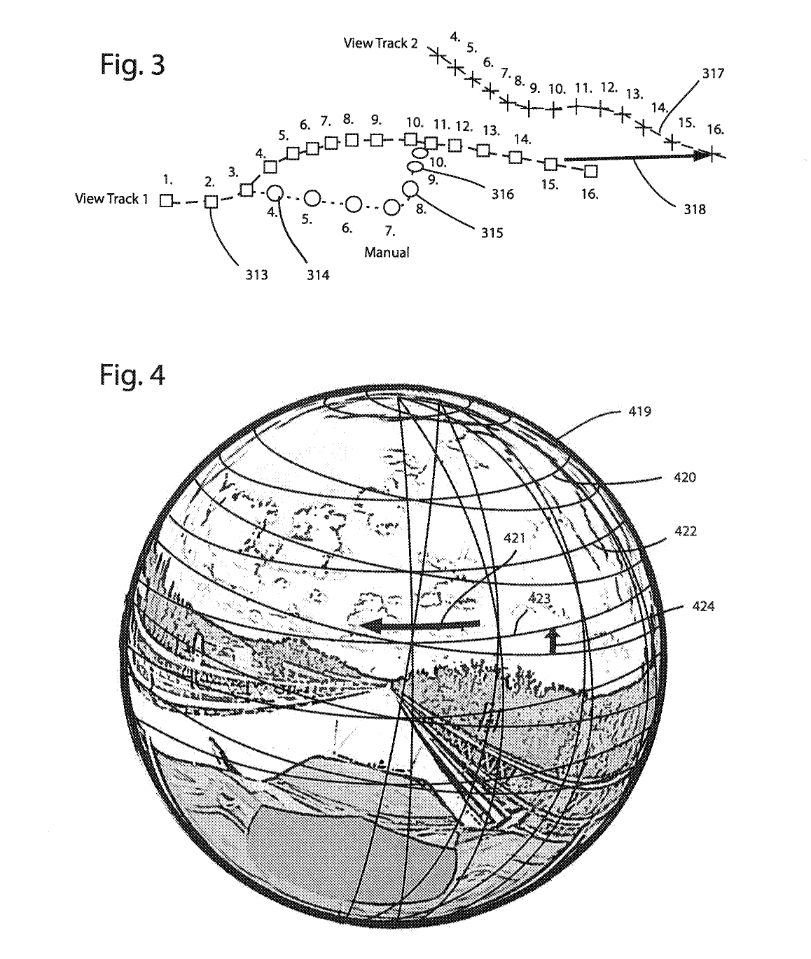

FIG. 3 illustrates a sequence of progressive changes in the ROI window center locations produced by automatic and manual control of the view direction. A first predefined View Track 313 is illustrated with squares denoting the center locations of ROI windows, per numbered frame, with a dashed line showing the connection between the successive ROI window locations. A second predefined View Track 314 is illustrated with crosses denoting the center locations of ROI windows, per numbered frame, with a dashed line showing the connection between the successive ROI window locations.

At manual control track 315 illustrates a sample direction of view that results when an observer asserts manual control over the ROI window during playback of View Track 313. Circles denote the center locations of ROI windows, per numbered frame, with a dashed line showing the connection between the successive ROI window locations during the observer's manual control. The observer can assert manual control of the direction of view, as illustrated by manual control track 315, with any user interface control associated with the observer's computer.

The manual control of the viewing direction takes the centers of the ROI windows to locations along manual control track 315 for frames 4-10 that differ from the locations of the ROI windows along View Track 313 for frames 4-10. At manual track end 316, corresponding to frame 8 along manual control track 315, the manual control asserted by the observer is released, and a transition track 317, denoted by ovals, begins to automatically rejoin manual track end 316 with automatic View Track 313.

Transition track 317 illustrates a preferred transition option in which ROI window locations, orientations, and fields of view from manual track end 316 are interpolated over multiple frames to rejoin automatic View Track 313, so as to make a smooth motion of transition to a subsequent frame (e.g., frame 11). The rate of motion for transition track 317 can be predefined according to the extent of the separation of manual track end 316 from automatic View Track 313 to prevent any discontinuities in the transition track 317 that would be jarring for the observer. The illustrated transition track 317 has a duration of two frames and is a relatively quick transition, like a rubber-band snap, but could occur over a greater number of frames for a smoother transition, with an appropriate easing in and easing out of the rate of motion, or within a single frame for a faster transition, although a faster transition could be too abrupt for the observer.

In addition, the observer can select between the first predefined View Track 313 and second predefined View Track 314, as illustrated by a View Track Selection 318. In the illustrated example, the observer happens to change from the first predefined View Track 313 at frame 15, so the second predefined View Track 314 begins playback at the next frame, frame 16. The illustrated View Track Selection 318 occurs over a single frame to provide a fast response to the observer's selection of a different view track. It will be appreciated, however, that View Track Selection 318 could include interpolation between the current and selected view tracks over multiple frames, in the manner of transition track 317, to provide a smoother transition between the predefined view tracks.

As an example, View Tracks 313 and 314 could represent or correspond to different characters in an immersive scene, or different targets within an environment included in the immersive scene. If multichannel directional sound is included in the immersive movie, the choice of a viewing direction, whether along predefined View tracks or manual control tracks, can be used to control the mixing of the sound channels so as to emphasize or simulate the sound coming from a particular direction, just as someone would be able to concentrate on a conversation in a particular direction from among the babble of voices at a cocktail party.

It will be appreciated that the view direction can instantly join the automatic track at its next location, or make a quick transition in a couple of frames like a rubber-band snap, but this sudden transition may be jarring to the user unless interpolation is used.

The assertion of manual control is accompanied by a signal to the playback processor. This signal of assertion can take many forms, such as a mouse click, keyboard key or button.

The media information which can be delivered to the user in the playback process, based on a given direction of view and frame of the immersive movie, can include not only directional sound, but also superimposed computer graphics objects or characters, and metadata links such as URL hotspots representing web sites or other media links. These too can be predefined in the View Track, so that parts of the ROI will become active in these ways during playback. When manual control is asserted, there is a larger problem of making special resources available to the roaming ROI no matter where it goes. The size and complexity of this set of choices can be managed by tiling the area of the sphere surrounding the automatic ROI region to include these outside resources, that are most likely to be used next, and shutting down the choices that will not be needed because they are too far away from the current ROI being used.

FIG. 4 shows a separation of a View Track into a Stabilization Track that corrects the orientation of the spherical image, and a Navigation Track which looks around within the stabilized spherical image. The unstabilized tilted spherical image is shown at 419. The view sphere 420 represents the orientation of the usual viewing controls for looking around within an immersive image. Aside from a roll control (for rotating an ROI about its center), these controls are mainly based on a horizontal motion (azimuth) 421 equivalent to lines of latitude 422 on a globe, and vertical lines (elevation) equivalent to lines of longitude 423. These are also known by other names, such as yaw and pitch. For a tilted spherical image, the horizon would run both above and below its usual position on the view sphere, so horizontal motion around the middle of the view sphere would produce an image both above and below the horizon instead of along it, and vertical motion in the viewer would not lead to a point directly overhead in the image. This can be corrected by reorienting the spherical image itself as part of the post production process, so that the spherical image output will always match the view sphere. But this is an inflexible approach that also requires considerable computational resources. A better approach is to make the ROI navigation more directly match the spherical image by use of a separate Stabilization Track.

This Stabilization Track correction shown at 424 can be directly generated by orientation information recorded along with the immersive image, such as the Inertial Measurement Unit (IMU) included along with the Applanix POS LV system used in IMC's camera cars used for immersive recordings of streets. With the Global Positioning Satellite (GPS), IMU and Distance Measurement Indicator (DMI) data from the POS LV system, a solution can be found for every frame of the immersive movie recording, accurate to less than a meter, and including the three-axis orientation of the camera in space, which represents the three-axis orientation of the resulting spherical image for each frame. Any offsets from a theoretical level sphere represented by these orientation readings are the basis for a Stabilization Track. If manual control is asserted when there is a Stabilization Track present, then the Navigation Track component of the View Track can be considered to be overridden, but the Stabilization Track can continue to be in effect, for better performance in looking around manually.

An example of an XML format for listing the location and attitude information for each frame is:

<xml>
<!-- GGA altitude is ellipsoid height not orthometric -->
<first_frame> 0 </first_frame>
<sensor_data>
<!-- <inertial_header>
<VehicleID> B1 </VehicleID>
<GPSBaseStation> USNO </GPSBaseStation>
<DatumName> ITRF00 (Epoch 1997.0) </DatumName>
<EllipsoidName> WGS84 </EllipsoidName>
<Grid> UTM North 18 (78W to 72W) </Grid>
<FramesyncMethod> Realtime NMEA </FramesyncMethod>
<FramesyncTimingStdDev> 0.0144277116686804
</FramesyncTimingStdDev>
</inertial_header> -->
<megaframe_sensordata>
<output_frame_number> 0 </output_frame_number>
<original_rdf_file_name> M:\Shot ~
May.23.08 13.55.20\IDX-0000.RDF
</original_rdf_file_name>
<original_frame_number> 21461 </original_frame_number>
<sensor_record>
<ggaLatitude> 38544280 </ggaLatitude>
<ggaLongitude> −77029305 </ggaLongitude>
<ggaLatitudeLong> 3854.42806 N </ggaLatitudeLong>
<ggaLongitudeLong> 07702.93056 W </ggaLongitudeLong>
<ggaAltitude> −13.41 </ggaAltitude>
<rmcHeading> 0.08 </rmcHeading>
<ggaUTC> 18075959 </ggaUTC>
<rmcDate> 230508 </rmcDate>
<inertial>
<GPSWeek> 1480 </GPSWeek>
<GPSSecond> 497293.599369556 </GPSSecond>
<DecimalLatitude> +38.907134307 </DecimalLatitude>
<DecimalLongitude> −77.048842634 </DecimalLongitude>
<EllipsoidHeight> −13.413974 </EllipsoidHeight>
<Easting> +322347.366938733 </Easting>
<Northing> +4308466.668393369 </Northing>
<NorthingStdDev> 0.415931 </NorthingStdDev>
<EastingStdDev> 0.351391 </EastingStdDev>
<Heading> +0.081386 </Heading>
<HeadingStdDev> 0.053200 </HeadingStdDev>
<Pitch> +1.358734 </Pitch>
<PitchStdDev> 0.015296 </PitchStdDev>
<Roll> −3.802881 </Roll>
<RollStdDev> 0.015162 </RollStdDev>
</inertial>
</sensor_record>
</megaframe_sensordata>

The recording of the viewing direction to make a Navigation Track can be done in several ways. The display for the ROI playback and capture and playback application can be the ROI itself, or a full sphere image such as an equirectangular worldview, or a combination of the two. On the worldview, the center of the ROI and its boundaries can be shown superimposed on the overall image. This enables an overview of the whole scene as a guide to extracting its best parts.

Recording and including the View Track should be part of the post production process for immersive movies. Since they are a part of the playback process for the frames of the movie, they should be able to be cut, dissolved, and otherwise manipulated by any editing program for making immersive movies.

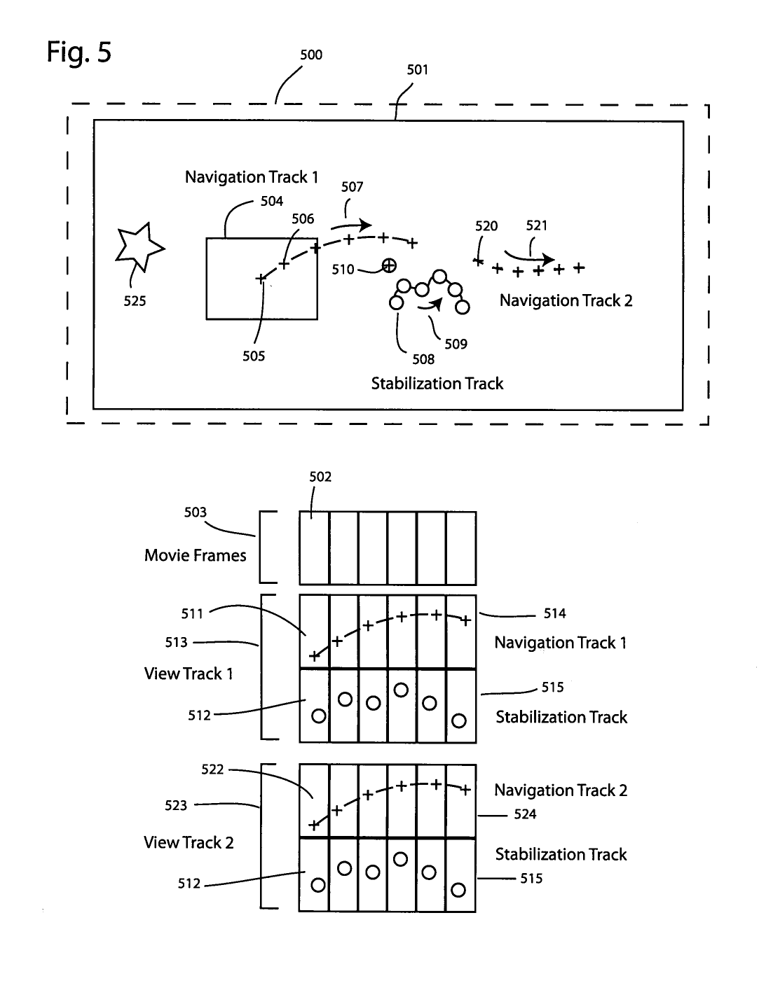

FIG. 5 shows the addition of a View Track to the playback of the immersive movie. Within the environment of an application executed on a computer platform 500, there can a display of the frames of an immersive movie, in this case a full-sphere equirectangular worldview image 501. A sequence of six movie frames are here shown superimposed.

A first frame 502 of an immersive movie sequence of frames 503 is displayed in the worldview display 501. During the recording process, the user then moves a ROI window around within the immersive image, and the playback application simultaneously records the ROI direction, as well as the FOV (i.e. zoom) and roll settings, for each frame. This can be done with the frames being played slowly, or at full speed. For accuracy, slow motion and repeat modes should be included, with the recorded ROI motion repeated to confirm that it is correct, so that the user can control the playback and repeat and refine the capture as necessary to get the best results. The ROI boundary 504 and center 505 of the first recorded ROI window are shown here, and a successive ROI selection 506 for a second frame. The sequence then continues with a succession of ROI selections with an overall direction 507. If there is an overall Stabilization Track available, that is added to the playback at the time of ROI capture, with the Stabilization offsets applied to normalize the immersive image before the ROI selection is made. The stabilization track offsets are here shown as a series of dots which could represent the original centers of the succession of frames, beginning at 508 and moving in a direction 509, compared to the corrected center 510. The numerical offsets here are shown schematically in a data record 511 corresponding to the ROI information 505 for the first movie frame 502, and a corresponding Stabilization Track record 512 for that movie frame corresponding to the Stabilization Track information 508. The final View Track 1 513 in this case contains both the Navigation Track 514 and Stabilization Track 515 components. These can be kept as separate files, or combined into a single file, to be kept separate or be recorded as part of the movie file itself.

If there is a need for making additional View Tracks, these can also be captured and stored in this way. A second Navigation Track is shown with a succession of ROI centers beginning at 520 and continuing in a direction 521. Similarly, the first record 520 also corresponds to the first movie frame 502, and can be recorded to correspond to the first movie frame 502, and also to the first frame of the Stabilization Track 512, to make a View Track 2, shown at 523, which also contains Navigation Track 2 524 and a copy, either literally or by synchronization, of Stabilization Track 515.

During playback, sound direction and mixing information can most easily be inferred from the visual direction measurements contained in the View Track for a given moment of time. For example, if the original recording contained four directional audio tracks corresponding to the directions of the compass, then a user facing “east” may hear more of the sound coming from that direction, with “north” in the left ear and “south” in the right ear. When the viewer is facing “west”, then this would be reversed, with “south” in the left ear and “north” in the right ear

The Stabilization Track also serves as a basis for the accurate superimposition of computer graphics (CG) objects such as 525 on the spherical image. With this track, the objects will more accurately stay “glued” to a part of the image, and not seem to bounce around independently. In addition, the inclusion of distance information allows for accurate correction of these objects in 3D perspective as the camera moves through the pictured environment.

Including this type of information enables the viewer to feel more comfortable being part of an immersive experience, by providing a bridge between a passive and an active approach for looking around within the immersive world.

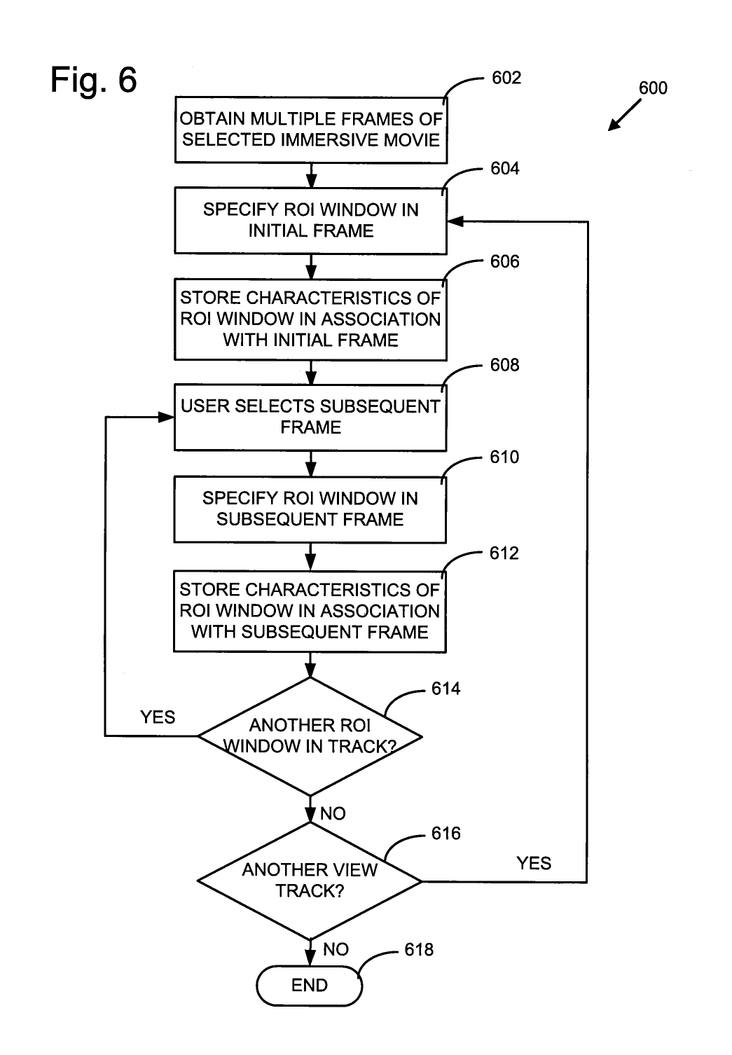

FIG. 6 is a flow diagram of an immersive movie view track definition method 600 in which a view track is defined in an immersive motion picture or movie. View track definition method 600 is generally implemented by software that is stored in a computer readable medium and executed or run on a computer in conjunction with a computer-operated viewer or player of immersive movies.

In step 602 multiple frames of an immersive movie are obtained as a selected immersive movie. Obtaining the selected immersive movie includes accessing all or part of a previously-stored immersive movie from data storage or a newly-recorded an immersive movie, or both.

In step 604 a user specifies a ROI window in an initial frame of the selected immersive movie. In specifying the ROI window, the user selects at least a viewing direction within the immersive movie and a viewing window size, if the viewing window size is selected to be other than a default size. The viewing direction may be selected through a graphical or other type of user interface, for example the tracker on a head-mounted display, by which the user rotates a view selection window about at least one axis, or two axes if available, within the immersive movie initial frame, until the view selection window encompasses the desired ROI window. Optionally, the user may also select changes from a default image zoom or magnification and a default ROI direction within the overall immersive field of view.

In step 606 the viewing direction, window size, and any other characteristics of the specified ROI window are stored in association with the initial frame as ROI window data. The ROI window data may be stored as a type of metadata that is included in the immersive movie or as a separate ROI window data file that is associated with the immersive movie.

In step 608 the user selects a subsequent frame in the immersive movie.

In step 610 the user specifies a ROI window in the subsequent frame of the selected immersive movie. In specifying the ROI window, the user selects at least a viewing direction within the immersive movie and a viewing window size, if the viewing window size is selected to be other than a default size. The viewing direction may be selected through the graphical or other type of user interface by which the user rotates the view selection window about at least one axis, or two axes if available, within the immersive movie initial frame until the view selection window encompasses the desired ROI window. Optionally, the user may also select changes from a default image zoom or magnification and a default ROI direction within the overall immersive field of view. The subsequent frame can be a next successive frame in the immersive movie following a previous frame in which a ROI window was specified.

In step 612 the viewing direction, window size, and any other characteristics including magnification of the specified ROI window are stored in association with the subsequent frame as ROI window data. The ROI window data may be stored as a type of metadata that is included in the immersive movie or as a separate ROI window data file that is associated with the immersive movie.

Step 614 is a query whether another ROI window is to be specified for a current view track in the immersive movie. If yes, step 614 returns to step 608. If no, step 614 proceeds to step 616.

Step 616 is a query whether another view track is to be specified for the immersive movie. If yes, step 614 returns to step 604 and recording begins on the first specified frame. If no, step 616 proceeds to process termination step 618.

View track definition method 600 allows a user to define one or more view tracks for an immersive movie, such as view tracks 313 and 314 illustrated in FIG. 3. In this implementation, in view track definition method 600 ROI window data are used to specify an initial ROI window and any changes to the ROI window in subsequent frames. The ROI window is deemed to remain unchanged for any intervening frames for which there is no new ROI window specified. Alternatively, the ROI window specified for a particular frame may be explicitly associated with each succeeding frame, until a new ROI window is specified, but in this alternative implementation the ROI window data would require more data storage space and data transmission bandwidth.

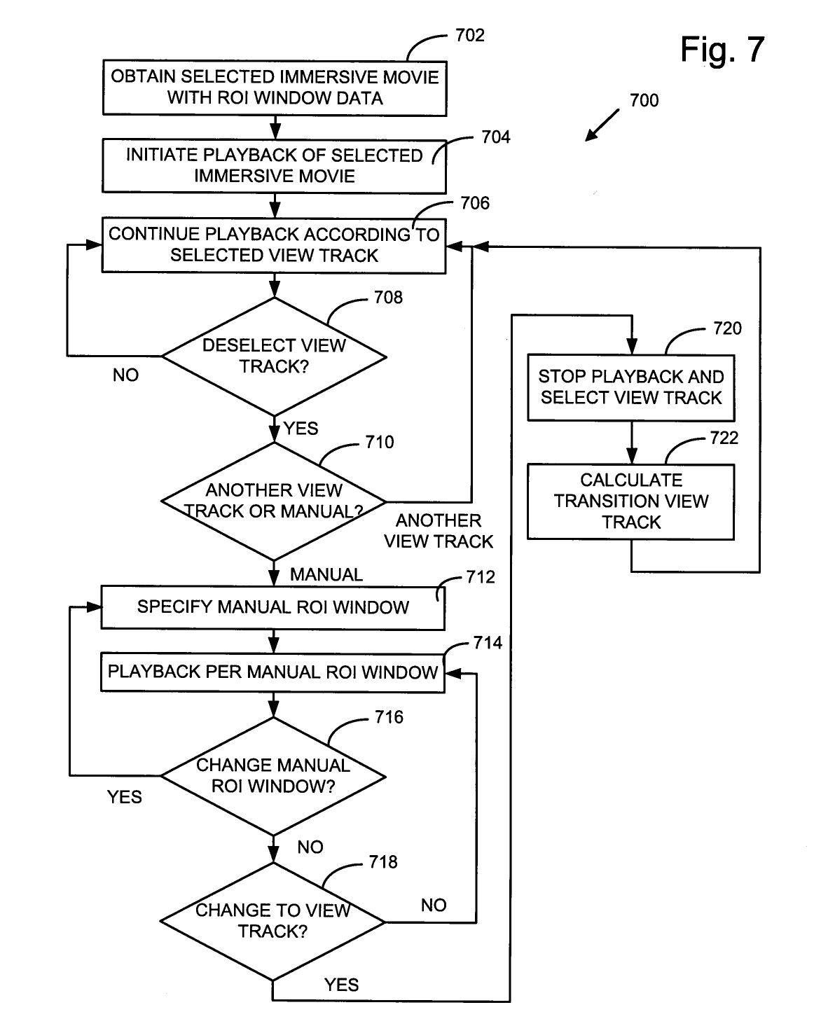

FIG. 7 is a flow diagram of an immersive movie view track playback method 700 in which an immersive motion picture or movie is played back to an observer according to one or more view tracks. View track playback method 700 is generally implemented by software that is stored in a computer readable medium and executed or run on a computer in conjunction with a computer-operated viewer or player of immersive movies.

In step 702 a selected immersive movie is obtained, together with associated ROI window data.

In step 704 an observer initiates playback of the selected immersive movie, beginning with a ROI window associated with the initial frame for a selected view track of the immersive movie. It will be appreciated that playback according to the selected view track may be an optional playback mode that is selectable by the observer, or may be a default mode that the observer my deselect.

In step 706 playback of the selected immersive movie continues according to the selected view track.

Step 708 is a query whether the observer deselects playback according to the selected view track. If no, step 708 returns to step 706. If yes, step 708 proceeds to step 710.

Step 710 is a query whether the observer selects another view track at the current frame or assumes manual control of the playback of the immersive movie at the current frame. Step 710 proceeds to 706 if the observer selects another view track as the selected view track. Step 710 proceeds to step 712 if the observer assumes manual control of the playback of the immersive movie. It will be appreciated that the availability of one or more other selectable view tracks may be indicated to the observer in a number of ways, such as by displaying static icons representing the tracks or moving visual indications in the immersive image, representing the centers or edges of the fields of view of the ROIs in the other tracks, or other indications of the objects of interest in the other tracks.

In step 712 the observer specifies a manual ROI window in a current frame of the selected immersive movie. In specifying the manual ROI window, the observer selects at least a viewing direction within the immersive movie and a viewing window size, if the viewing window size is selected to be other than a default size. The viewing direction may be selected through a graphical or other type of user interface by which the user rotates a view selection window about at least one axis, or two axes if available, within the immersive movie initial frame until the view selection window encompasses the desired ROI. Optionally, the user may also select changes from a default image zoom or magnification and a default ROI direction within the overall immersive field of view.

In step 714 the immersive movie is played back according to the manual ROI window from the current frame.

Step 716 is a query whether the observer changes the manual ROI window. If yes, step 716 returns to step 712. If no, step 716 proceeds to step 718.

Step 718 is a query whether the observer deselects manual playback in favor of one or more available view tracks as of the current frame. If no, step 718 returns to step 714. If yes, step 718 proceeds to step 720.

In step 720 playback of the immersive movie is stopped and the observer selects a view track from among one or more available view tracks as of the current frame. If more than one view track is available, the multiple available view tracks may be displayed as graphic indicators, either static or in motion within the immersive image, that are selectable by the user through a graphical or other type of user interface.

In step 722 a transition view track is calculated from the manual ROI window of the current frame to a ROI window of the selected view track for a subsequent frame. The subsequent frame may be a next successive frame, but would typically be multiple frames after the current frame so that the transition view track can change from the manual ROI window of the current frame to the ROI window of the selected view track for the subsequent frame in a smooth manner.

The transition track functions to transition any changes required between the viewing direction, viewing window size, image zoom, or audio mix of the manual ROI window of the current frame to the viewing direction, viewing window size, image zoom, or audio mix of the ROI window of the selected view track. The number of frames over which the transition track is run is selected to provide a visually smooth transition in the minimum amount of time that allows the observer to perceive the intervening change from the final manual ROI window to the ROI window of the selected view track at the subsequent frame. Step 722 returns to step 706.

As described above, an immersive movie according to the present disclosure can include one or more predefined view tracks that guide an observer's view during playback of an immersive movie. In the described implementations, the immersive movie includes a sequence of immersive frames that are analogous to the sequence of frames in a conventional movie or video. In addition, an immersive movie according to the present disclosure, referred to as a multi-threaded immersive movie, can be incorporated, associated, or linked together using multiple separate sequences of immersive movie frames, each sequence being referred to as an immersive movie thread. Each immersive movie thread functions as a separate immersive movie, with or without one or more View tracks therein.

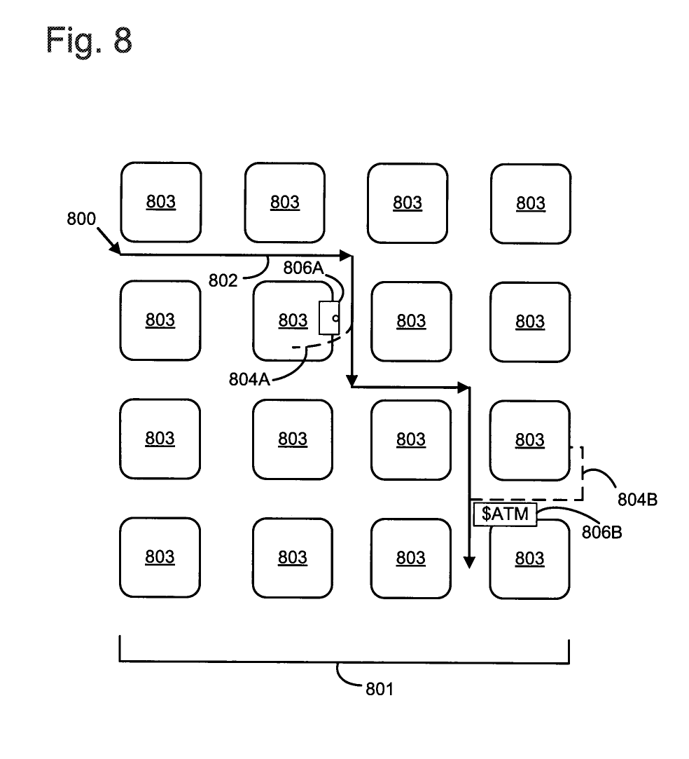

FIG. 8 is a schematic graphical illustration representing a multi-treaded immersive movie 800 as it is applied, for example, to a prerecorded immersive movie of travel within a city. In this illustration, portions of multi-treaded immersive movie 800 are indicated on a simplified map of a city 801 as a path between city blocks 803 along which the immersive movie is recorded so that successive locations along the path correspond to successive frames in the immersive movie 800. This example is used merely for purposes of illustrating operation of the disclosure and does indicate a limit of the scope or application of the disclosure.

Multi-treaded immersive movie 800 includes a base immersive movie thread 802 (indicated by solid line) that begins the multi-threaded immersive movie 800 and functions as the base or trunk from which one or more branch immersive movie threads 804 are accessed. Base immersive movie thread 802 is distinguished from the one or more branch immersive movie threads 804 by being the thread that runs from the beginning of multi-treaded immersive movie 800. (Two sample branch immersive movie threads 804A and 804B are indicated.) With regard to the illustrative example, base immersive movie thread 802 corresponds to and records travel along streets within the city.

A first branch immersive movie thread 804A is accessible at a branching link 806A that is incorporated into base immersive movie thread 802. Branching link 806A may be represented by a graphical indicator (e.g., a graphical or photo-realistic icon having a two- or three-dimensional representation) that is embedded and viewable in base immersive movie thread 802 to indicate availability of branch immersive movie thread 804A. Branching link 806A operates as a link to branch immersive movie thread 804A, but also corresponds to a spatial location in the view recorded in base immersive movie thread 802.

In one implementation, an observer watching base immersive movie thread 802 according to a selected view track would see branching link 806A draw closer over multiple frames with the apparent motion imparted by the travel within the city. At any point that it is in view, branching link 806A can be activated or “clicked” as a graphical or other type of user interface control to access corresponding branch immersive movie thread 804A. For example, branch immersive movie thread 804A could correspond to a prerecorded immersive movie, or other recorded media, corresponding to travel within a building on interest or note along the path of base immersive movie thread 802. as a result, observer activation of branching link 806A can result in the playback of branch immersive movie thread 804A, providing a tour with the building of note.

During playback of a branch immersive movie thread 804, the observer can elect to return to the base immersive movie thread 802 by activating a graphical or other type of user interface control.

In addition, a second branch immersive movie thread 804B may also be accessible at a branching link 806B that is incorporated into base immersive movie thread 802. Branching link 806B may be represented by a graphical indicator (e.g., a graphical or photo-realistic icon having a two- or three-dimensional representation, in this case representing an automatic teller machine (ATM)) that is embedded and viewable in base immersive movie thread 802 to indicate availability of branch immersive movie thread 804B. Branching link 806B operates as a link to branch immersive movie thread 804B, but also corresponds to a spatial location in the view recorded in the base immersive movie thread 802.

It will be appreciated that branching links 806 may be selected to indicate to a user the type of information or material to be accessed, for example a branching link 806 leading into a building could be indicated as a building or a doorway, and a branching link to a historical site could be indicated by a moving picture icon showing the past event. In addition, it will be appreciated that branch immersive movie threads can branch from other branch immersive movie threads, in addition to branching from base immersive movie thread 802.

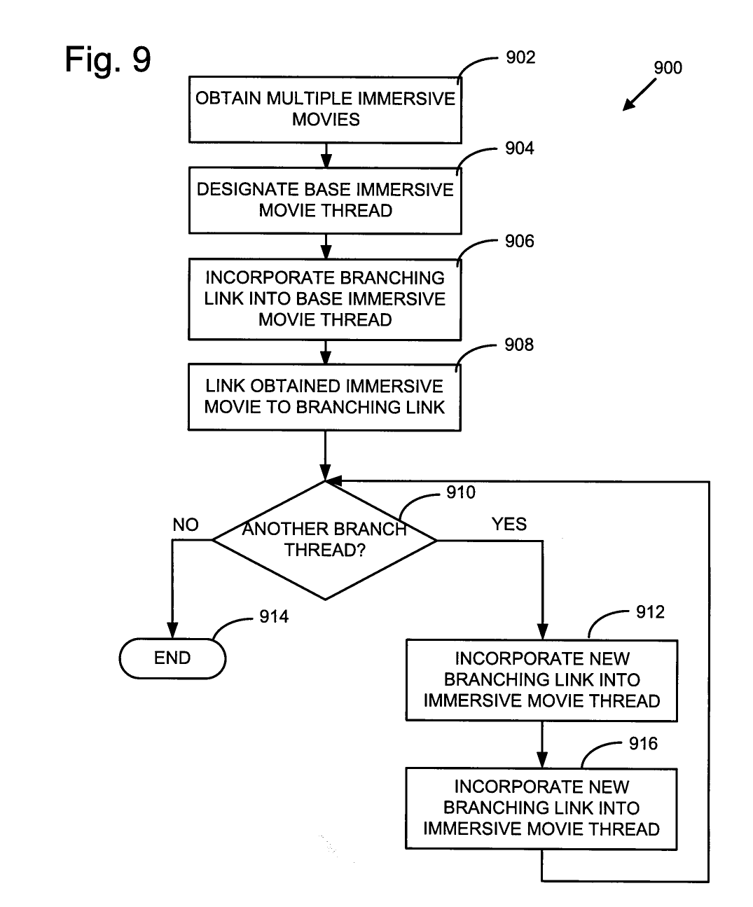

FIG. 9 is a flow diagram of a multi-threaded immersive movie construction method 900 for constructing or assembling a multi-threaded immersive movie of the type described with reference to FIG. 8. Multi-threaded immersive movie construction method 900 is generally implemented by software that is stored in a computer readable medium and executed or run on a computer in conjunction with a computer-operated viewer or player of immersive movies.

In step 902 two or more (i.e., multiple) immersive movies are obtained for inclusion into a multi-threaded immersive movie. Any of the immersive movies may be obtained from data storage as previous recordings or may be newly recorded. Also, any of the immersive movies may include associated ROI window data, or not.

In step 904 one of the immersive movies is designated a base immersive movie thread, which begins the multi-threaded immersive movie and functions as the base or trunk from which one or more branch immersive movie threads are accessed.

In step 906 a branching link is incorporated into base immersive movie thread.

The branching link may be represented by a graphical indicator (e.g., a graphical or photo-realistic icon having a two- or three-dimensional representation) that is embedded and viewable in one or more frames of base immersive movie thread, typically being viewable in multiple frames.

In step 908 one of the obtained immersive movies is linked to and made accessible from the branching link as a branch immersive movie thread.

Step 910 is a query whether another branch immersive movie thread is to be incorporated into the multi-thread immersive movie. If yes, step 910 proceeds to step 912. If no, step 910 proceeds to termination step 914.

In step 912 a new branching link is incorporated into an immersive movie thread of the multi-threaded immersive movie. The new branching link may be represented by a graphical indicator (e.g., a graphical or photo-realistic icon having a two- or three-dimensional representation) that is embedded and viewable in one or more frames of the immersive movie thread, typically being viewable in multiple frames.

In step 916 one of the obtained immersive movies is linked to and made accessible from the new branching link as a branch immersive movie thread. Step 916 returns to step 910.

### Operations, Ramifications and Scope

It will be appreciated by one skilled in the art that the present disclosure can also be presented in other embodiments. For example, when viewing an immersive movie over the web, the View Track can be delivered to the user via a separate server on the web, according to a choice dependent on the level of access. One or more View Tracks may be available to the user based on a given security or access level. So a user who is willing to sign up for enhanced playback features may be given a View Track that points out clues in a complicated mystery situation, or other details that would otherwise be overlooked.

A variety of View Tracks can be used for a choice, depending on the results of the previous playback. For instance, in following the action through an immersive movie, a number of View Tracks may describe intersecting paths on the view sphere. If a previous choice has been to follow a particular View Track, such as a particular character, and the goal of the overall playback is to enable a more complex story to be shown, then a previous choice, such as a manual reorientation taken to focus on another character, can be used as a justification to switch to the View Track for that character if the paths intersected.

The audio component of the playback for a given View Track can be based on the soundtrack for the immersive movie as a whole, or it can reflect a different soundtrack, such as the inner thoughts of a character who is the focus of the View Track.

The forms of the immersive movies can vary according to the capabilities of the playback system. Digital files are normally used, usually in a compressed form. Local playback typically allows for the delivery of a higher bandwidth of data than over the web. The area of the image can be a full immersive image showing a substantial portion of a sphere, a panorama showing a strip extending up to 360 degrees, or even a wide angle image which records more than can be easily seen at once. The immersive images and the View Track can be generated live from the image source, with a View Track being generated by a camera operator or director looking around in the image, or be the result of playback from some storage medium.

Although this disclosure has been particularly illustrated in the context of an immersive imaging system, it will be recognized that certain of these improvements likewise find applications in other contexts, e.g., single sensor imaging systems, and stereoscopic systems where multiple offset camera systems are used. Similarly, although image sensors operating in the visible light spectrum are contemplated, the same principles can likewise be applied for sensors operating at other wavelengths. In addition, computer graphics image generators can be used to generate the immersive movie frames, either wholly or in combination with photographic recordings.

Metadata such as image overlays can also be delivered as part of the image, depending on the frame rate and available bandwidth. For example, commentaries, maps, and other graphic information about the image in view can be called upon and added to the delivered image feed, either from the original image source or by calling upon auxiliary servers, if the bandwidth and the frame rate allow it. For example, an elaborate set of image overlays can be displayed over or as part of a still image freeze frame, whereas such overlays could be too confusing and be changing too rapidly for a moving picture.

The View Track and the immersive movie can be on a client or a server. If the immersive movie delivered to a client, the whole immersive movie image and the View Track should be present, especially if optional manual control is also desired. This produces a large amount of bandwidth, unless limiting approach are used that restrict the delivery of the immersive movie image to the region including and surrounding the current region of interest. If the immersive movie is on a server, then more computing resources are needed for each client, but the needed bandwidth can be restricted to the region of interest, for the delivery of higher resolution within the same bandwidth, without the need to deliver any portion of the image that will be invisible.

It will be evident to artisans that features and details given above are exemplary only. Except where expressly indicated, it should be understood that none of the given details is essential; each is generally susceptible to variation, or omission. It should be apparent to those of ordinary skill in the art what particular applications of the novel ideas presented here may be made, given the description of the embodiments. Therefore, it is not intended that the scope of the disclosure be limited to the specific embodiments described, which are merely illustrative of the present disclosure and not intended to have the effect of limiting the scope of the claims.

I claim:

1. A wide angle motion picture image viewing system with a stored path for the direction of a moving region of interest, comprising:
A digital image source with a processor for the delivery of a sequence of images representing the frames of a wide angle motion picture sequence upon the request of a playback application, and
At least one View Track associated with said motion picture sequence, comprising a set of directional viewing instructions which are used upon request by said playback application for automatically defining the region of interest for a plurality of said frames, comprising,
A frame index, for said plurality of said frames,
Azimuth direction information for the center of a region of interest for each of said plurality of said frames,
Elevation direction information for the center of a region of interest for each of said plurality of said frames,
Field of View information for defining the extent of the region of interest for each of said plurality of said frames; wherein
Playback of the motion picture frame triggers the automatic display of the region of interest defined for that frame in the View Track, unless manual control is asserted by a control to the playback application to change the region of interest, and if said manual control is released, then as the frames of the motion picture sequence increment, there is a transition from the last region of interest settings set by manual control to the automatic region of interest settings contained in said View Track.

2. The system of claim 1, wherein said transition comprises a smoothed motion.

3. The system of claim 1, wherein said View Track represents a recording made of the manual control settings from a prior playback of said motion picture sequence.

4. The system of claim 1 wherein said View Track is a separate file.

5. The system of claim 1 wherein said View Track also controls the directional characteristics of any audio associated with said motion picture sequence.

6. The system of claim 1 wherein one of a plurality of View Tracks is chosen at a time by the playback application.

7. The system of claim 1 wherein said View Track comprises a Stabilization Track for the reorientation of the image sphere, and a Navigation Track defining movement across the surface of the stabilized image sphere.

8. The system of claim 7, wherein said manual control overrides only the Navigation Track, and not the Stabilization Track.
